(19) United States
(12) Patent Application Publication
(10) Pub. No.: US 2010/0165196 A1
(43) Pub. Date: Jul. 1, 2010

(54) AV PRESENTATION SYSTEM INCLUDING AN RCU FOR CONTROLLING AT LEAST ONE AV PRESENTATION DEVICE

(75) Inventors: Linda S. Bailey, San Diego, CA (US); Lance Hobrock, Olivenhain, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/344,970

(22) Filed: Dec. 29, 2008

(51) Int. Cl. H04N 3/27; H04N 5/66

(52) U.S. Cl. 348/554; 348/739; 348/E03.049; 348/E05.133

(57) ABSTRACT

An AV presentation device that may be installed as part of an AV presentation system including a television display device includes an RCU for emitting a user signal in response to user actuation and a base unit for connection to the television display device. The base unit includes an input element for receiving the user signal and, responsive thereto, launching a browser application that runs on the base unit and generates a signal for displaying a browser window on the television display device. The base unit also includes a memory storing a file which, when opened by the browser application, displays in the browser window a document including instructions pertaining to the RCU.

### BACKGROUND OF THE INVENTION

The subject matter of this application relates to an audio-video (AV) presentation system including a remote control unit (RCU) for controlling at least one AV presentation device.

A conventional AV presentation system, such as a home theater system, comprises a television display unit (TV set) and at least one other AV presentation device, such as an AV receiver, a digital video disc (DVD) player or a so-called set top box (STB). In a typical installation the STB includes a decoder that receives television program material in the form of an encoded bitstream, decodes the encoded bitstream and supplies the TV set with a composite signal having an audio component and a video component in accordance with an industry standard, such as the High-Definition Multimedia Interface (HDMI) standard. The TV set displays a sequence of pictures and presents associated audio to a user of the system.

Current mechanisms for delivering the encoded bitstream to the STB include cable, direct broadcast satellite and IPTV (Internet Protocol Television) over DSL (Digital Subscriber Line). A preferred implementation of the subject matter disclosed in this application is used in a system that receives television program material by IPTV over DSL and accordingly the disclosure in this application relates principally to such a system.

In the conventional system referred to above, the user must control the STB and the TV set in order to watch television programs and must control the TV set and the DVD player, and perhaps also the AV receiver, in order to watch a program recorded on a DVD.

The user may interact with an AV presentation device using an infrared RCU. The typical infrared RCU includes an array of buttons or keys that may be selectively pressed by the user. The RCU responds to pressing of a key by energizing an LED to emit an IR signal that is coded in a manner that depends on the particular key that has been pressed. The IR signal is received by a suitable infrared sensor in the presentation device. The presentation device recovers the code from the received signal and executes the command that the user invoked by pressing the key. Generally, each manufacturer of AV presentation devices employs a unique set of codes for controlling respective functions of that manufacturer's presentation devices. For example, a manufacturer of DVD players would typically employ a set of codes for controlling such functions as POWER, PLAY, PAUSE, STOP, FAST FORWARD and RAPID REVERSE. If the manufacturer also manufactures TV sets, its set of codes would also include codes for controlling such functions as TV power, service selection (i.e. channel up and channel down), volume up and volume down.

Generally, each AV presentation device is provided with its own dedicated RCU that is programmed to emit only the IR signals coded for the functions of the particular AV presentation device. A user who wishes to watch television may select the RCUs for the TV set and the STB and press appropriate keys on the RCUs to turn on the STB and the TV set, select the desired TV service, set the input selector of the TV set to select the STB, and adjust the sound volume to a desired level. Alternatively, a user who wishes to watch a program recorded on a DVD may select the RCUs for the TV set, the DVD player and the AV receiver and press appropriate keys on the RCUs to turn on the DVD player, the AV receiver and the TV set, set the input selector of the TV set to select the AV receiver, adjust the sound volume using the AV receiver, and control play back of the DVD using the DVD player. The proliferation of dedicated RCUs may lead to clutter, confusion and conflict.

In an AV presentation system that includes an STB, service selection is performed by the STB rather than by the TV set. Accordingly, it has become conventional for the RCU that is supplied with an STB to be a programmable dual function RCU and include controls that allow that RCU to control the TV set, in order to eliminate the need for at least one dedicated RCU. Therefore, when first setting up an AV presentation system including an STB, the user will typically select the dual function RCU to control not only the STB but also the TV set and will program the RCU to transmit the proper codes for controlling the TV set. The RCU may have a mode switch that allows the user to select TV or STB, and in order to program the RCU the user sets the mode switch to select TV and enters a numeric ID using the number keys on the RCU. The numeric ID, which may be specified in the user guide for the STB, is unique to the manufacturer of the TV set. The RCU saves the numeric ID. The RCU includes a memory storing a look up table specifying function codes for control of a TV set, indexed by the numeric manufacturer ID. Thereafter, when the user sets the mode switch to select TV and presses a key (or combination) associated with a function of the TV set, the RCU uses the previously-stored numeric ID to read function codes from the memory and employs those function codes to code the IR signal emitted by the LED. It will be appreciated that since service selection is accomplished by the STB, the principal function codes that need to be stored in the RCU for controlling the TV set are the codes for ON/OFF, volume control of the TV set, and TV/VIDEO input selection.

In the event that the user purchases a new TV set from a different manufacturer, a dual function RCU that has been programmed to control the old TV set likely will not control the new TV set in the expected manner. If, in the meantime, the user has lost or discarded the user guide for the RCU, the user may not be able easily to reprogram the dual function RCU to control the new TV set.

In order to protect against the possibility of the new TV set using a set of function codes that were not stored in the dual function RCU at the time the dual function RCU was manufactured, the dual function RCU may have the capability to “Learn” new function codes either by communicating electronically with the STB or by capturing the IR signal from the dedicated RCU that was provided with the new TV set. In this situation, if the user has lost or discarded the user guide for the RCU, the user may not be able to easily reprogram the RCU to “Learn” the function codes need to control the new TV set.

In addition to the dual function RCUs that are provided with STBs for controlling both the STB and the TV set, universal RCUs are available for controlling all the common components of an AV presentation system. Such universal RCUs can be programmed to control not only the STB and the TV set but also other presentation devices such as a DVD player and an AV receiver.

The universal RCU may have a mode switch for selecting a component of the AV presentation system and when the mode switch is in the appropriate position for controlling, for example, an AV receiver, the user may program the RCU by entering the AV receiver's numeric manufacturer ID. Subsequently when the mode switch selects the AV receiver, pressing the volume control button on the RCU will cause the LED to emit an IR signal that is coded to control the AV receiver rather than the TV set. In this case, programming of the RCU is more complex since the user must enter a manufacturer ID not only for the TV set but also for the other components of the AV presentation system. Because programming is more complex, it is more difficult to recover from loss of the RCU user guide.

Other universal RCUs treat a multi-component AV presentation system as one or more integrated sub-systems, such that once the RCU has been programmed with manufacturer IDs for the respective components, it is not necessary to use a mode control switch to control each individual component but it is sufficient to select a function, such as WATCH TV or PLAY a DVD. For example, selecting the function PLAY a DVD in the case of the system shown in FIG. 1 may cause the RCU to emit IR signals coded to switch on the TV set, the AV receiver and the DVD player (but not the STB) whereas pressing the VOLUME UP button causes the RCU to emit an IR signal coded to increase the volume of the AV receiver. At least one RCU of this type is programmed by connecting the RCU to a computer that is connected to the Internet and allows the user to specify the components of the AV presentation system through controls displayed in a browser window and download appropriate programming data from the RCU manufacturer's Internet website to the RCU through the user's computer.

### SUMMARY OF THE INVENTION

In accordance with a first aspect of the claimed subject matter there is provided an AV presentation device that may be installed as part of an AV presentation system including a television display device and comprises an RCU for emitting a user signal in response to user actuation, and a base unit for connection to the television display device and that includes an input element for receiving the user signal and, responsive thereto, launching a browser application that runs on the base unit and generates a signal for displaying a browser window on the television display device, and wherein the base unit includes a memory storing a file which, when opened by the browser application, displays in the browser window a document including instructions pertaining to the RCU.

In accordance with a second aspect of the claimed subject matter there is provided a method of operating an AV presentation device that may be installed as part of an AV presentation system including a television display device, the method comprising receiving a user signal and, responsive thereto, launching a browser application than runs on the presentation device and generates a signal for displaying a browser window on the television display device, accessing an HTML file containing instructions pertaining to the RCU, employing the browser application to open the HTML file and display the instructions pertaining to the RCU in the browser window.

In accordance with a third aspect of the claimed subject matter there is provided a computer readable medium containing software that, when executed by an AV presentation device installed as part of an AV presentation system including a television display device in response to a user signal from an RCU, causes the AV presentation device to launch a browser application than runs on the presentation device and generates a signal for displaying a browser window on the television display device, access an HTML file containing instructions pertaining to the RCU, and employ the browser application to open the HTML file and display the instructions pertaining to the RCU in the browser window.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates in simplified form an AV presentation system including an AV presentation device embodying the subject matter disclosed in this application,

FIG. 2 is a block diagram illustrating in greater detail the RCU and STB shown in FIG. 1,

FIG. 3 illustrates a first browser window that may be displayed on the TV set in the AV presentation system shown in FIG. 1, and

FIG. 4 illustrates a second browser window that may be displayed on the TV set in the AV presentation system shown in FIG. 1.

### DETAILED DESCRIPTION

Referring to FIG. 1, a telephone system operator 6 operates a proprietary network 8 over which it distributes television program material to subscribers in the form of an encoded bitstream by IPTV over DSL. The encoded bitstream is received at a subscriber premise at which there is installed an AV presentation system that comprises a TV set 10, an AV receiver 12, a DVD player 14 and an STB 16.

The STB includes a decoder that decodes the encoded bitstream and supplies the TV set with a composite signal having an audio component and a video component in accordance with an industry standard, such as the Advanced Television System Committee (ATSC) standards or the High Definition Multimedia Interface (HDMI) standard. The TV set displays a sequence of pictures and presents associated audio to a user of the system. At least the TV set and the STB are controlled by a dual function infrared RCU 20.

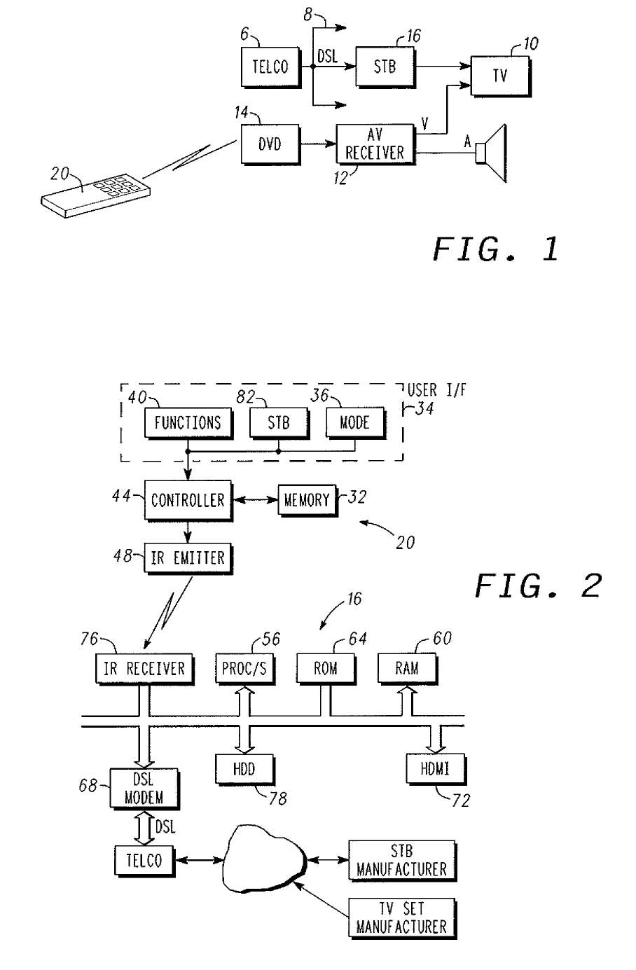

Referring to FIG. 2, the RCU 20 includes a non-volatile memory 32 that stores the function codes associated with STB operation and a lookup table containing the function codes associated with operation of TV sets of different manufacturers, indexed by reference to unique numeric manufacturer IDs. The RCU also includes a user interface 34 that includes a mode switch 36 that can be set to select STB or TV, and function keys 40 configured and/or labeled to denote the common functions associated with the STB and the TV set. As is conventional, the function keys of the user interface includes a group of navigation keys (up, down and left, right) for navigating an interactive program guide and an OK key for selecting the service currently specified in the guide. The function keys interact with a controller 44 in a manner that depends on the setting of the mode switch and the current state of the controller. For example, if the RCU has been programmed to specify that the TV set was manufactured by Sony Corporation and the mode switch of the user interface is currently set to select TV, and in this state the user presses a key related to a TV set function, the controller fetches the appropriate function code from the Sony code list and supplies the selected function code to the IR emitter, which emits an IR signal coded with the appropriate function code. If the mode switch is currently set to STB and the user presses a key related to an STB function, the controller fetches the appropriate function code and supplies the function code to the IR emitter, which then emits an IR signal coded with that function code.

In the initial (default) condition of the RCU, the channel (or service) and volume controls are set to control the IPTV receiver.

The STB 16 comprises one or more processors 56, random access memory 60, read only memory 64, and various interfaces organized in a generally conventional architecture as a special purpose computing machine adapted for operation as an STB for receiving an encoded bitstream by IPTV over DSL. Thus, the interface devices include a DSL modem 68 for connection to the Telco network 8, an HDMI transmitter 72 for connection to the TV set, and an IR receiver for detecting the IR signal emitted by the RCU and recovering the function code. Particularly in the event that the STB incorporates not only an IPTV receiver, for receiving an encoded bitstream and generating in real time a composite video signal, but also a personal video recorder (PVR), the STB may also include one or more hard disk drives 78.

If the mode switch is currently set to TV and the user presses a key or a combination of keys for watching TV, the processor(s) may execute an application for selecting a program service, decoding the encoded bitstream for that service and providing data to the HDMI transmitter for generating a signal in accordance with HDMI standards for supplying to the TV set.

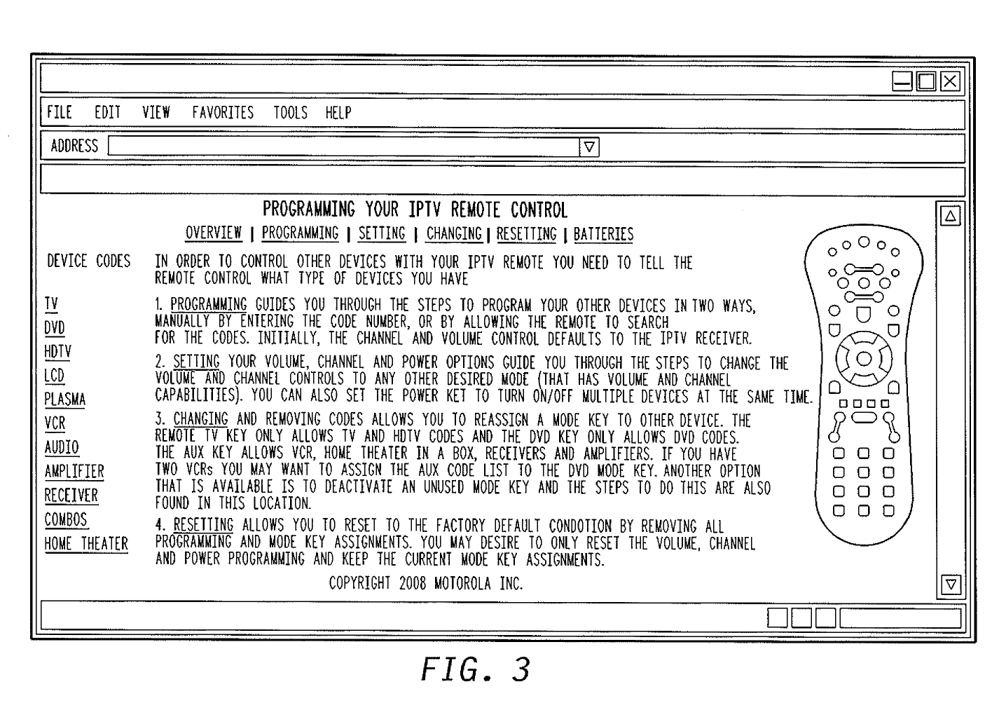

In addition to the usual function keys for controlling the components of the AV presentation system, the user interface 34 of the RCU includes a special purpose key 82 that, in the illustrated embodiment, is labeled STB. When the user presses the STB key, the STB responds to the command transmitted by the RCU by launching an network browser application and the bitstream provided to the HDMI transmitter causes the TV set to display a browser window containing a predetermined home page that visually represents the content of an extensible hypertext markup language (XHTML) file, such as an index.htm file as shown in FIG. 3. The index.htm file is typically stored locally, in the memory of the STB. The browser application also displays a cursor that can be moved within the browser window using the navigation keys of the RCU.

The index.htm file includes at least one hypertext link that is composed of descriptive text, which may be displayed with a distinct visual attribute, such as light blue color, and contains a hidden reference to a universal resource locator (URL) that specifies the location on the network of another XHTML files. We will assume initially that these other XHTML files are also stored locally on the STB. By use of the navigation keys, the user can position the cursor over one of the hypertext links and by pressing the OK key, the remote control unit issues a signal coded with a command to which the STB responds by sending a hypertext transfer protocol (HTTP) request to the server specified in the URL hidden in the hyperlink and the server responds to the request by forwarding the requested file to the browser application. The browser application receives the requested XHTML file and, in familiar fashion, displays the XHTML page to the user for viewing in a browser window.

Referring again to FIG. 3, in a preferred embodiment, the hypertext links in the index.htm file point to different chapters (overview, programming, setting, changing, resetting, batteries) of a complete user guide for the RCU. Such a user guide bears a functional relationship to the RCU, in that by following the instructions in the RCU, the RCU behaves in the manner explained in the user guide. By selecting and activating any one of the links in the index.htm file, an XHTML file containing the text of the appropriate chapter of the user guide is activated and the selected chapter is displayed in the browser window. As shown in FIG. 3, the programming chapter of the user guide contains instructions that guide the user through the steps to program the RCU to control the TV set either manually by entering a numeric manufacturer ID or by entering a manufacturer name and allowing the STB, in response to a command from the RCU, to search for a manufacturer ID and store the manufacturer ID in the memory 32.

It will be appreciated that a given chapter may be organized by sections or topics and that the top level file for a given chapter may contain links to the sections or topics. The entire chapter may be contained in a single XHTML file or in multiple chapters in two or more levels. In the former case, selecting and activating a link may cause the displayed window to jump to a different location in the file; in the latter case, selecting and activating a link in an upper level XHTML file causes a lower level XHTML file to be selected and displayed.

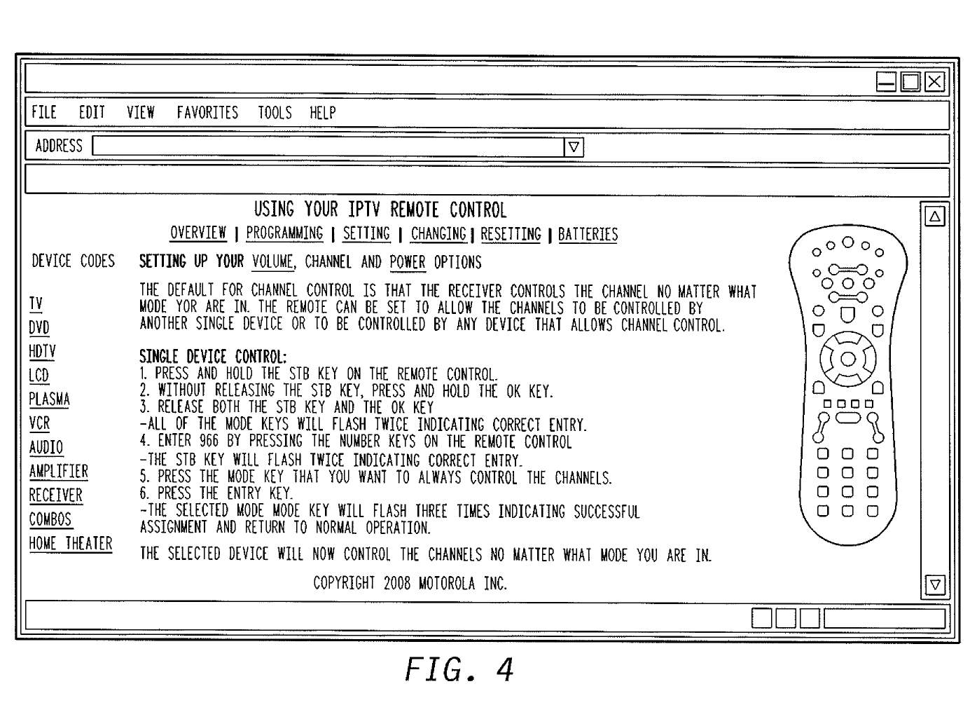

As indicated in FIG. 4, information for setting functional options of the RCU may be presented in text form, allowing the user to read instructions from the screen of the TV set and press the appropriate sequence of keys on the RCU to program the RCU. Alternatively, one or more of the links may launch an animation sequence, such as a FLASH animation displayed in a portion of the Internet browser window, depicting the operations for setting function options. The animation may be more helpful than text instructions for some users.

As noted above, the XHTML files containing the user guide may be stored in memory on the STB. The files may be updated from time to time by the Telco over the proprietary network 8, for example in the event of a firmware update to the STB requiring a change in instructions for setting functional options or in the event that user experience reveals that clarification or augmentation of the instructions is desirable. In other embodiments of the disclosed subject matter, the XHTML files may be stored at the Telco office 6 or at the STB manufacturer's Internet website.

The links in the XHTML files may also provide access to information pertaining to other components of the AV presentation system. For example, if the user programs the RCU to select the Sony code list for the TV set, a link in the index.htm file may provide access to XHTML files containing user guides for the TV sets manufactured by Sony Corporation. Another possibility is that the XHTML file that lists TV manufacturers may include hyperlinks to other XHTML files containing user guides for the TV sets of the respective manufacturers. The links to XHTML files containing user guides for components other than the RCU may point to universal resource locators (URLs) at network locations remote from the STB

Many electronic devices are manufactured as special purpose computing machines and accordingly the subject matter disclosed in this application is not restricted to the index.htm file (and perhaps other XHTML files) being stored in memory of the STB. For example, user guide information may be stored in memory of the TV set or AV receiver.

Moreover, the disclosed subject matter is not restricted to user guide information for an RCU that is especially designed to control an STB and may be used to provide user guide information for a universal RCU.

The subject matter disclosed in this application is not restricted to the STB receiving IPTV over DSL since XHTML files for updating the contents of the memory of the STB may be delivered by cable or DBS, although these mechanisms do not provide upstream communication capability. Upstream communication capability may be provided by telephone service.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of the claims beyond the literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. An AV presentation device that may be installed as part of an AV presentation system including a television display device and comprises:
an RCU for emitting a user signal in response to user actuation, and
a base unit for connection to the television display device and that includes an input element for receiving the user signal and, responsive thereto, launching a browser application that runs on the base unit and generates a signal for displaying a browser window on the television display device,
and wherein the base unit includes
a memory storing a file which, when opened by the browser application, displays in the browser window a document including instructions pertaining to the RCU.

2. A device according to claim 1, wherein the file contains a hyperlink to an animation.

3. A device according to claim 1, wherein the file contains a hyperlink to another file.

4. A device according to claim 1, wherein the base unit is an STB and the RCU comprises a memory storing codes for controlling operation of the television display device.

5. A device according to claim 1, wherein the RCU is a dual function RCU for controlling both an STB and a television display device.

6. A method of operating an AV presentation device that may be installed as part of an AV presentation system including a television display device, the method comprising:
receiving a user signal and, responsive thereto, launching a browser application than runs on the presentation device and generates a signal for displaying a browser window on the television display device,
accessing an HTML file containing instructions pertaining to the RCU,
employing the browser application to open the HTML file and display the instructions pertaining to the RCU in the browser window.

7. A computer readable medium containing software that, when executed by an AV presentation device installed as part of an AV presentation system including a television display device in response to a user signal from an RCU, causes the AV presentation device to:
launch a browser application than runs on the presentation device and generates a signal for displaying a browser window on the television display device,
access an HTML file containing instructions pertaining to the RCU, and employ the browser application to open the HTML file and display the instructions pertaining to the RCU in the browser window.
